(19) United States
(12) Patent Application Publication
(10) Pub. No.: US 2021/0278671 A1
(43) Pub. Date: Sep. 9, 2021

(54) HEAD WEARABLE DEVICE WITH ADJUSTABLE IMAGE SENSING MODULES AND ITS SYSTEM

(71) Applicant: HES IP HOLDINGS, LLC, Spring, TX (US)

(72) Inventors: Yung-Chin HSIAO, Taipei City (TW); Jiunn-Yiing LAI, New Taipei City (TW); Huan-Yi LIN, Huntington Beach, CA (US); Sheng-Lan TSENG, Taoyuan City (TW)

(73) Assignee: HES IP HOLDINGS, LLC, SPRING, TX (US)

(21) Appl. No.: 17/179,423

(22) Filed: Feb. 19, 2021

Related U.S. Application Data
(60) Provisional application No. 62/978,322, filed on Feb. 19, 2020.

(51) Int. Cl. G02B 27/01; G06K 9/00

(52) U.S. Cl. CPC G02B 27/0172; G02B 2027/0138; G06K 9/00302

(57) ABSTRACT

A head wearable display system includes a head wearable device for a user and an image processing module, to process the images captured by a first image sensing module and a second image sensing module. The head wearable device includes a frame to be worn on the user's head, a display module, disposed on the frame. The first image sensing module to capture images in a first direction toward the user's face, and the second image sensing module to capture images in a second direction away from the user's face. In this device, the first image sensing module and the second image sensing module are adjustably mounted on the frame.

### CROSS-REFERENCE TO THE RELATED APPLICATION

This patent application claims priority to U.S. Provisional Patent Application Ser. No. 62/978,322, filed on Feb. 19, 2020, entitled “Head Wearable Device with Inward and Outward Cameras”, which is assigned to the assignee hereof and is herein incorporated by reference in its entirety for all purposes.

### TECHNICAL FIELD

The present invention relates to a head wearable device, especially concerns with the head wearable device with multiple adjustable image sensing modules.

### DESCRIPTION OF RELATED ART

Virtual reality or virtual realities (VR) (also sometimes interchangeably referred to as immersive multimedia or computer-simulated reality) describes a simulated environment designed to provide a user with an interactive sensory experience that seeks to replicate the sensory experience of the user's physical presence in an artificial environment, such as a reality-based environment or a non-reality-based environment, such as a video game. A virtual reality may include audio and haptic components, in addition to a visual component.

The visual component of a virtual reality may be displayed either on a computer screen or with a stereoscopic head-mounted display (HMD), such as the Rift, a virtual reality head-mounted display headset developed by Oculus VR of Seattle, Wash. Some conventional HMDs simply project an image or symbology on a wearer's visor or reticle. The projected image is not slaved to the real world (i.e., the image does not change based on the wearer's head position). Other HMDs incorporate a positioning system that tracks the wearer's head position and angle, so that the picture or symbology projected by the display is congruent with the outside world using see-through imagery. Head-mounted displays may also be used with tracking sensors that allow changes of angle and orientation of the wearer to be recorded. When such data is available to the system providing the virtual reality environment, it can be used to generate a display that corresponds to the wearer's the angle-of-look at the particular time. This allows the wearer to “look around” a virtual reality environment simply by moving the head without the need for a separate controller to change the angle of the imagery. Wireless-based systems allow the wearer to move about within the tracking limits of the system. Appropriately placed sensors may also allow the virtual reality system to track the HMD wearer's hand movements to allow natural interaction with content and a convenient game-play mechanism.

### SUMMARY

A head wearable display system includes a head wearable device for a user and an image processing module, to process the image captured by a first image sensing module and a second image sensing module. The head wearable device includes a frame to be worn on the user's head, a display module, disposed on the frame. The first image sensing module to capture image in a first direction toward the user's face, and the second image sensing module to capture images in a second direction away from the user's face; wherein the first image sensing module and the second image sensing module are adjustably mounted on the frame.

The first image sensing module is able to capture the whole facial image, partial facial image, or partial posture image of the user, and the image processing module can determine user expression information, including facial and posture expression, according to the images captured by the first image sensing module.

The system further comprises a storage module to store the pre-stored images. The pre-stored images are the user's real facial or avatar images which may be transmitted or displayed according to the user expression information.

In one embodiment, the image processing module uses the pre-stored images and the images captured by the first and/or the second image sensing module to reconstruct a user's image with facial expression and/or posture expression.

In one embodiment, the system further comprises a communication module to transmit information to or receive information from the internet. The system may further comprise a location positioning module to determine the location information of the system.

A head wearable device worn by a user includes a frame to be worn on the user's head, a display module, disposed on the frame and multiple image sensing modules adjustably mounted on the frame. The image sensing modules, for capturing images from different view angles. Each image sensing module is mounted to a receiving position of the frame via an attachment structure of the image sensing module and the receiving position is adjustable.

In one embodiment, the image sensing module can be moved via the attachment structure to adjust the receiving position or a view angle. The attachment structure may comprise a hinge joint to adjust the view angle of the image sensing module. The image sensing module is electrically connected to the frame via the attachment structure to receive power supply or to transmit data.

In one embodiment, the attachment structure is a concave structure or a convex structure. The frame may include a rail structure for the image sensing module to move via the attachment structure.

In one embodiment, the display module can project a 3-dimensional image with multiple depths.

In one embodiment, the image sensing module is positioned to take images toward or away from the user's face.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The above and other aspects, features and advantages of the invention will be more apparent from the following more particular description thereof, presented in conjunction with the following drawings wherein

FIG. 1A is the side view of one embodiment of the present invention.

FIG. 1B is the top view of one embodiment of the present invention.

FIG. 2 is a diagram of another embodiment.

FIG. 3 is a system diagram of the embodiment.

FIGS. 4A and 4B are illustrated another embodiment with multiple cameras

FIG. 5 is the application scenario for a remote meeting

FIG. 6 is a working flowchart of the image processing process

FIG. 7 is the application scenario of the embodiments.

### DETAILED DESCRIPTION OF EMBODIMENTS

A head wearable display system comprises a head wearable device and an image processing module. The head wearable device further comprises a frame to be worn on a user's head, a display module, and multiple image sensing modules adjustably mounted on the frame. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

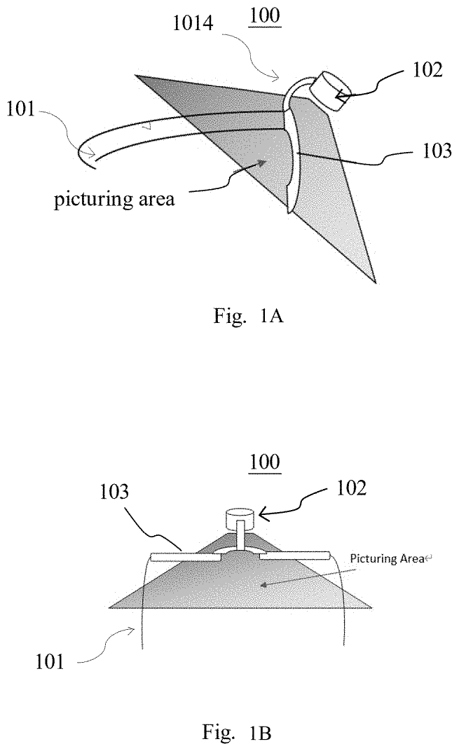

FIG. 1A and FIG. 1B show a first embodiment of the present invention. FIG. 1A is the sideview of the illustrated head wearable device and FIG. 1B is the top view of the illustrated head wearable device. In FIGS. 1A and 1B, a head wearable device 100, such as a helmet, a head mountable device, a wearable augmented reality (AR), virtual reality (VR) or mixed reality (MR) device, or a pair of smart glasses, includes a frame 101 (temple portion shown), at least one image sensing module 102 and a near-eye display module 103 (lens/combiner portion shown).

In the present embodiment, the image sensing module 102 is pointed toward the face of the user of the head wearable device 100. The triangle zones illustrated in FIGS. 1A and 1B are picturing areas of the image sensing module 102. It means the field of view (FOV) of the image sensing module 102. In some embodiments, the image sensing module 102 can be a camera incorporated with wide-angle lens, zoom lens, fish-eye lens, or multi-purposes lens for various applications. The wide-angle lens may be incorporated in the inward camera in order to obtain a wider view angle to capture as much facial image as possible. In addition, the camera is not limited to optical camera but also includes an infrared camera for measuring temperature, a range imaging sensor (such as a time-of-flight camera etc.) for measuring depth, and other physical parameters measurement sensing module.

In some embodiment, the image sensing module 102 is rotatable. It's either pointed outwardly for capturing images of the surroundings or pointed inwardly for recording the images of the facial expression, posture, and eye-ball movement of a user of the head wearable device 100.

An image sensing module 102 that captures the facial and/or upper body images of a user is referred to as an inward camera. An image sensing module that captures images of the outward surroundings is referred to an outward camera. A rotatable image sensing module can function as both an inward camera and an outward camera.

In some embodiment, the inward cameras capture important image of the user's face for some specific applications. For example, the inward camera captures images containing all or some important facial features for face restoration, reconstruction and recognition. The important facial features include at least eyes, nose, mouth, and lips. Another application is for facial expression. Other than the above feature points of the face, the image of facial muscles including orbital, nasal, and oral muscles can also be captured. Another application is for eye-ball tracking. The relative position of pupil on each eye can also be derived from images captured by the inward camera.

An outward camera can be used for many applications, such as navigation, indoor or outdoor walking tours (such as in museums and sightseeing places), sharing for social purpose, AR gaming, fabrication/operation guide . . . etc. An outward camera can function as telescope or microscope by using zoom in or zoom out lenses. For example, when an outward digital camera with extremely high resolution, such as 20-50 Mega or even 120 Mega pixels, is zoomed in on a small area, it can function as a microscope to help a human brain surgery. Such a head wearable device can be used in lots of applications, such as medical operation or precise production in factory.

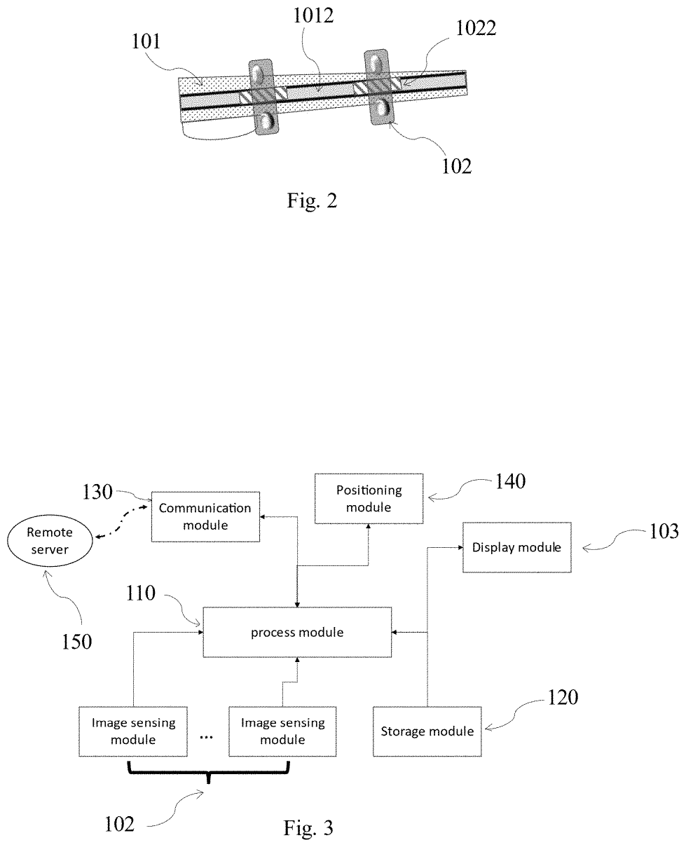

FIG. 2 is another embodiment of the present invention. In the present embodiment, the head wearable device 100 can include both an inward camera and an outward camera in the image sensing module 102. To get a better view angle for capturing images, the image sensing module 102 is adjustably mounted on the frame 101. In FIG. 2, the frame 101 includes a rail structure 1012. The image sensing module 102 has an attachment structure 1022 which is inserted into the rail 1012 so that the image sensing module 102 can slide and move along the rail 1012. Besides, there are power lines and data transmission lines embedded in the rail 1012. The image sensing module 102 is powered up by the power lines in the rail 1012 and the image data captured by the image sensing module 102 is transmitted with data line in the rail 1012.

In another embodiment, the image sensing module 102 is attached onto the frame 101 by a hinge joint. In FIGS. 1A and 1B, the frame 101 is physically connected with the image sensing module 102 with a hinge joint 1014. The hinge joint 1014 allows image sensing module 102 to rotate so that the direction the image sensing module 102 faces is adjustable according to the application scenario. In the current embodiment, the user can adjust the image sensing module 102 to aim at the whole face to capture the facial expression or to aim outwardly to capture the image of the surrounding environment. The adjustable design allows the image sensing module 102 to improve or optimize the feature capture of the user's face based on face shape and/or size of each user.

FIG. 3 is the system diagram of the head wearable device 100. The head wearable device 100 comprises a plurality of image sensing modules 102 for capturing images inwardly and outwardly, an image processing module 110 for processing images and determining image information, and a storage module 120 for storing the images and the image information. The image sensing modules 102 may include a first image sensing module and a second imaging module. In this embodiment, the image sensing modules capture user's or environmental images. The image processing module 110 can then process to recognize the images from the image sensing modules, including determining the user facial expression information or posture expression information in the user's images, and objects in the environmental images. In some embodiment, the image sensing module 102 only capture images at certain specific view angle and the image processing module 110 can reconstruct the user's image in a more completed manner (such as the user's entire face and posture) with facial and posture expression based on those images at certain specific view angle which are captured by different image sensing modules 102. Furthermore, some images can be stored in the storage module 120 in advance. In some scenario, the user of the head wearable device 100 only needs to turn on some specific image sensing modules aiming at the key facial expression features, like the mouth, lips, eyebrows, and eyeballs of the users, to obtain the partial real time images. The image processing module 110 can retrieve the previously stored images and user information from the storage module 120 to reconstruct the real time image or to form an animation.

The head wearable device 100 further includes a near-eye display module 103. In one embodiment, the near-eye display module 103 is the retinal projecting display designed to project the information, light signals or image onto the user's retinas directly through user's pupils. Moreover, the retinal projecting display can display the images with multiple depths. In other words, various objects in the image can have different depths. In another embodiment, the near-eye display module 103 can be the display in the known AR glasses, smart glasses and VR display. A PCT Patent Application with International Application Number PCT/US20/59317, filed on Nov. 6, 2020, entitled “System and Method for Displaying an Object with Depths,” assigned to the assignee hereof, is incorporated by reference in its entirety for all purposes.

Besides, the wearable head device 100 may also include a communication module 130, like Wi-Fi, Bluetooth, 4G, or 5G communication module to receive or transmit the images or user information, including user facial and/or posture expression information to a remote server 150. In addition, the head wearable device may have a location positioning module 140, like GPS or gyroscopes, to determine the location or orientation information of the head wearable device 100 and transmit that information to the image processing module 110 for further application or for the display on the display module 103.

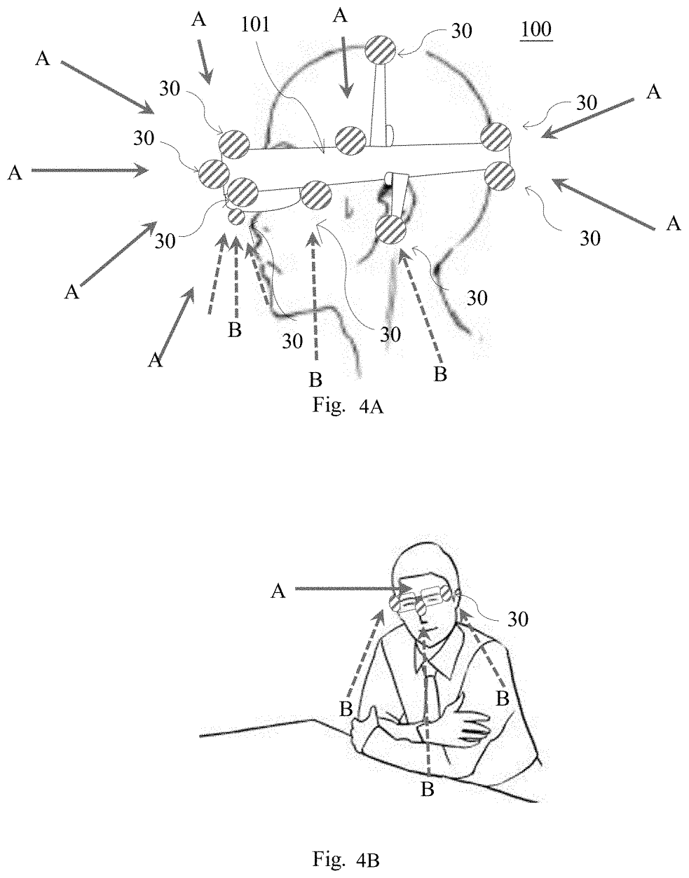

FIG. 4A and FIG. 4B illustrate another embodiments of the present invention. They illustrate the locations to mount the image sensing modules 102 on the frame 101. In FIGS. 4A and 4B, the circles 30 on the frame 101 indicate various receiving positions where the image sensing modules are respectively mounted on the frame 101.

The solid line arrows A indicate the view angles of the environmental images captured by the image sensing modules mounted at the specific receiving positions shown by circles 30, and the dash line arrows B indicate the view angles of the facial, gesture or posture images captured by the image sensing modules mounted at the specific receiving positions shown by circles 30.

In the present embodiment, some image sensing modules mounted at some specific receiving positions shown by circles 30 are able to capture either the environmental images or the user's facial, gesture, or posture images respectively and some image sensing modules mounted at some specific receiving positions shown by circles 30 are able to capture both of the environmental images and inward images, like users' facial, gesture, and posture, at the same time.

The images will be processed and analyzed by a processing module (not shown) in the head wearable device 100 or in the remote server connected via the communication module such as on the internet (not shown) for the further applications.

In the present embodiment, each of the image sensing module 102 merely captures a user's partial facial images or a partial posture images since the distance between the user's face or body and image sensing module 102 on the head wearable device 100 are too short to capture the entire face or body image. The facial or posture images captured by the image sensing modules 102 will be transmitted to an image processing module which can use such images to reconstruct a more completed or even an entire image for determining the user's facial expression and/or posture expression information.

The partial images and the entire image can be stored in the storage module (not shown) of the head wearable device 100. The stored partial images and entire images can be served as the user's image database. In some scenario, the user only needs to turn on some of the image sensing modules aiming at important features of the facial expression, like the mouth, and eyebrow. The image processing module of the head wearable device will use the real time images such as mouth/lips/eyeball/eyebrow and the stored images to reconstruct new entire (or more completed) images.

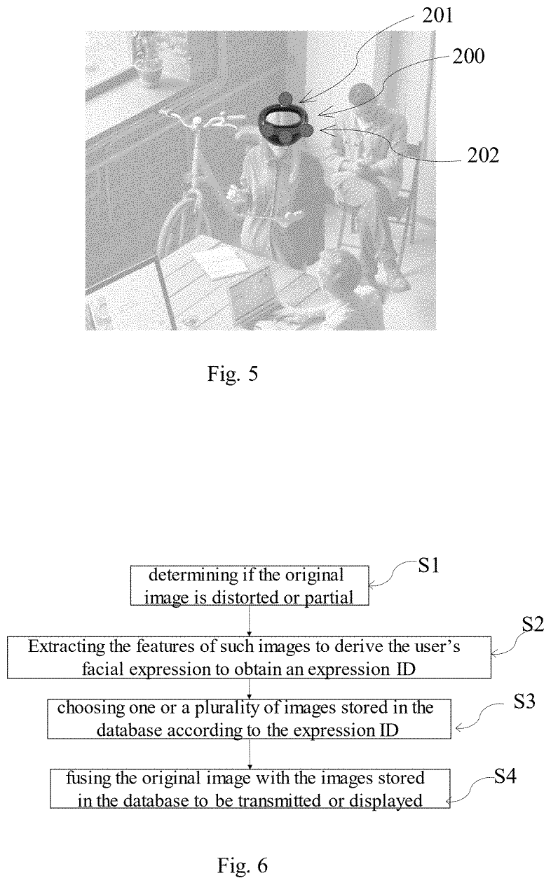

FIG. 5 illustrates another embodiment of the present invention, the head wearable device 200 includes a plurality of image sensing modules such as pivot cameras 202 on the frame 201 of the head wearable device. The pivot cameras 202 can be mounted on the different receiving positions of the frame 201. The images, including photos and videos, taken by the camera 202 of the head wearable device 200 may be further processed and transmitted to other users of head wearable devices via one or more servers. In the present embodiment, one pivot camera 202 is disposed on the back head of a user to capture the real time background image behind the user. The background images can be integrated with images, like user's facial images and posture images, captured by the other pivot cameras 202 to provide omni-direction image information.

The head wearable device 200 with AR/VR/MR function may be able to display a 3D image with multiple depths. In addition to images, the head wearable device 200 may be incorporated with a microphone and a speaker for recording and playing sounds. Moreover, the head wearable device may be incorporated with global positioning system (GPS) and/or gyroscopes to determine the position and orientation of the device.

The head wearable device 200 with AR/VR/MR (collectively “extended reality”) functions as described in this disclosure may free both hands to do some other things while executing most, if not all, of the functions a smart phone currently can provide such as taking photos and videos, browsing webpages, downloading/viewing/editing/sharing documents, playing games, communicating with others via text, voice, and images.

The image includes photo and video. The operation of the one or more cameras can be pre-programmed or controlled by touch, voice, gesture, or eyeball moving. In such circumstances, the head wearable device may have a touch panel, a voice recognition component, a gesture recognition component and/or eyeball tracking component. The touch panel can be a 3D virtual image with multiple depths displayed in the space so that the head wearer device can determine whether a touch occurs, for example by a depth-sensing camera taking the depth of the user's finger tips. Alternately, the head wearable device may have a remote control or be connected to a smart phone or a remote server for the touch, voice, or gesture control of the camera operation. In another embodiment, the one or more cameras can be controlled remotely by a person other than the user of the head wearable device. Such a person (possibly a second user or wearer) can see the images from the first user's camera and control that camera (with or without the approval of the first user). For example, a first user of the head wearable device is examining a broken machine to decide how to repair it but cannot figure out the problem. At this time, a supervisor (a second user) can remotely control the camera to examine a specific spot/component of the machine to solve the problem. Another example is a supervising doctor can remotely control the camera on the first user's device in front of a patient to examine a specific part of the body for diagnosis.

FIG. 6 is the working flow chart of the image processing module in one embodiment. The images of the user's face and body taken by the image sensing module may be processed to derive more information about the user for further use in AR/VR/MR applications. For example, the full or more completed facial images may be restored or reconstructed if the original facial images taken by the camera are distorted because of the angle or lens (such as wide-angle lens) used to capture the images with or without the pre-stored facial images. The following steps illustrate the method of processing the images. The method includes:

In Step S1, the original facial image is determined if the original image is distorted or partial due to the view angle or the property of the lens;

In Step S2, the distorted facial image may be analyzed by extracting the features of such images to derive the user's facial expression, such as happiness, sadness, anger, surprise, disgust, fear, confusion, excitement, desire, and contempt, and obtain an expression ID;

In Step S3, choosing one or a plurality of images stored in the database according to the expression ID; and

In Step S4, reconstructing a more completed or even entire facial image corresponding to the expression ID by using the original image and the images retrieved from the database for transmission or display.

As a result, one of pre-stored facial images corresponding to the facial expression can be used for transmission and/or display.

In another embodiment, the user may select a pre-stored avatar (such as a cartoon or movie character) corresponding to the facial expression for himself/herself without displaying his/her own real facial images. In addition, the inward camera may track the movement of the eyeball to derive the direction of gaze. The result of eye-tracking may be used for the design of AR/VR/MR applications. In another embodiment, the result of eye-tracking may direct another camera (such as an outward camera) to catch the surrounding images the device wearer/user is gazing.

Similarly, the images of the outward surroundings and part of the user's body (such as position of fingers/hands, types of gestures, and body postures) taken by a camera (inward and/or outward camera) may be processed to derive more information about the wearer/user and the environment for further use in AR/VR/MR applications. For example, the images can be processed by an object recognition component which can be part of the head wearable device or located in a separate server. A tag may be added to a recognized object to provide its name and description. In one scenario, a wearer/user attends a meeting and sees a few other attendees whose facial images are taken and processed. If any of these attendees is recognized, his/her name and description will be displayed in the tag shown next to such attendee's image via the display module or AR glasses. In addition to tags, other virtual objects can be created and displayed for AR/VR/MR applications. In one scenario, a virtual object such as an arrow can be displayed in an AR/MR navigation system. Another example is that the position of user's fingers/hands, types of gestures and body postures may also be analyzed and recognized to derive more information about the wearer/user. In one scenario, a specific gesture may be an instruction or order to the head wearable device. The depth sensing camera on the head wearable device can sense gestures of the wearer/user to interact with the AR/VR/MR application of displaying 3D images with multiple depths for commanding and controlling various available functions of the head wearable device. In one scenario, the camera can sense the depth of a gesture, such as the depth of finger tips and the moving of hands, so that the head wearable device with AR/VR/MR application of displaying 3D images with multiple depths can determine whether the fingertip virtually touches a specific image/object in space or whether a finger gesture satisfies the pre-defined zoom-in/out instruction to initiate such a function. For the surrounding images, the outward camera with a zoom lens may zoom in as a telescope to capture and display the close images of a specific spot.

In addition to cameras, the microphone, the speaker, the GPS, and the gyroscope may be integrally incorporated with the head wearable device or attached (but removable if needed) to the head wearable device, for example by plugging in a connector or a socket built on the head wearable device.

The data/information/signals, such as images, sounds and other information, taken by cameras, microphones, GPS and gyroscopes, may be transmitted by wiring or wireless communication, such as telecommunication, Wi-Fi, and Bluetooth, to another component of the head wearable device or a separate server for further processing on either the head wearable device, or a separate server, or both.

After being processed, the images and/or sounds are transmitted to audiences. In one scenario, a journalist or reporter (such as we-media) may wear a head wearable device with at least one camera. The journalist/reporter can first turn the camera inward to himself/herself and speak to audiences on the web, so his/her audiences can see who is reporting. At the next moment, the camera is turned outward to the surroundings, so the audiences can see the images that he/she is reporting about. Another scenario is that the head wearable device is incorporated with at least one inward camera for images of the face and upper body of the journalist/reporter and at least one outward camera for images of the surroundings. Thus, the audiences can watch images of both the journalist/reporter and the surroundings at the same time. With such a head wearable device, a journalist/reporter can produce a real-time investigative report or an on-spot interview alone without a separate camera man.

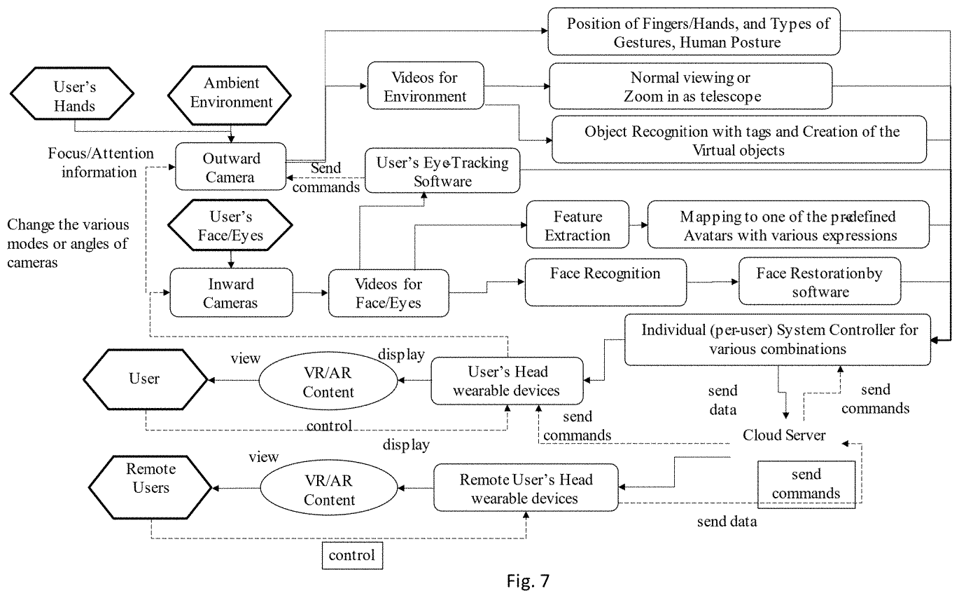

In addition, as shown in FIG. 7, a plurality of users of the head wearable device can interact with each other. If the head wearable devices have AR/VR/MR functions, the wearers/users can participate in a virtual video conference. The plurality of wearers/users can be located at separate spaces (for example each joins from his/her own home or office) or the same space (including all at the same space or some at the same space). All data/information, including images and sounds taken by cameras and microphones, from a sending wearer/user may be wholly or partially processed at the head wearable devices and/or a separate server, such as a cloud server, before being transmitted to a receiving wearer/user. The data/information from GPS and gyroscopes may be used to arrange spatial relationships among the wearers/users and the images displayed by the AR/VR/MR components of the head wearable devices. With such head wearable devices, wearers/users may join the virtual video conference anytime anywhere, such as lying down at home, sitting in a car or office, walking on streets, investigating a production line problem, without sitting in a room with a 360-degree video and audio system. As discussed before, each wearer/user may choose to display to other wearers/users his/her real facial image or its substitute such as an avatar (e.g. movie stars, or cartoons objects). In a virtual video conference, each wearer/user can watch the same 3D virtual image/object from a specific angle. That specific angle may be adjusted based on the movement of the wearer/user. In addition, a wearer/user may be able to watch the 3D virtual image/object from the same angle another wearer/user watches the image/object. For example, three surgeons wearing the head wearable device stand around a patent lying on an operation table to conduct a surgery, another remote wearer/user may be able to see the images each of the three head wearable devices can see from a different angle.

The AR//MR function of a head wearable device may project a 3D virtual image with multiple depths on top of a physical object so that the corresponding parts of the 3D virtual image and the physical object overlap. For example, a computed tomography (“CT”) scan image of a patient's heart may be processed and displayed as a 3D virtual image on top of (superimposing) the patient's heart during the surgery as an operation guide.

Although the description above contains much specificity, these should not be construed as limiting the scope of the embodiment but as merely providing illustrations of some embodiments. Rather, the scope of the invention is to be determined only by the appended claims and their equivalents.

What is claimed is:

1. A head wearable display system, comprising:
a head wearable device for a user, comprising:
a frame to attach the device on the user's head
a display module, disposed on the frame;
a first image sensing module to capture images in a first direction toward the user's face; and
a second image sensing module to capture images in a second direction away from the user's face; wherein the first image sensing module and the second image sensing module are adjustably mounted on the frame; and
an image processing module, to process the images captured by the first image sensing module or the second image sensing module.

2. The system according to claim 1, wherein the first image sensing module is able to capture the whole facial image, partial facial image, or partial posture image of the user, and the image processing module can determine user expression information according to the images captured by the first image sensing module.

3. The system according to claim 2, the system further comprises a storage module to store multiple pre-stored images.

4. The system according to claim 3, the pre-stored images corresponding to the user expression information can be transmitted or displayed.

5. The system according to claim 3, wherein the pre-stored images are user's real facial images or avatars.

6. The system according to claim 5, wherein the image processing module uses the pre-stored images and the images captured by the first or second image sensing module to reconstruct a user's image with facial expression.

7. The system according to claim 1, further comprising a communication module to transmit information to or receive information from the internet.

8. The system according to claim 1, further comprising a location positioning module to determine the location information of the system.

9. The system according to claim 1, wherein the display module is to display local images or remote images.

10. A head wearable device worn by a user, comprising:
a frame to be worn on the user's head;
a display module, disposed on the frame;
multiple image sensing modules adjustably mounted on the frame, wherein each image sensing module is mounted to a receiving position of the frame via an attachment structure of the image sensing module, and the receiving position is adjustable.

11. The device according to claim 10, wherein the image sensing module can be moved via the attachment structure to adjust the receiving position or a view angle.

12. The device according to claim 10, wherein the attachment structure further comprises a hinge joint to adjust the view angle of the image sensing module.

13. The device according to claim 10, wherein the image sensing module is electrically connected to the frame via the attachment structure to receive power supply or to transmit data.

14. The device according to claim 10, wherein the attachment structure is a concave structure or a convex structure

15. The device according to claim 10, wherein the frame includes a rail structure for the image sensing module to move via the attachment structure.

16. The device according to claim 10, wherein the display module can project a 3-dimensional image with multiple depths.

17. The device according to claim 10, wherein the image sensing module is positioned to take images toward or away from the user's face.
